(19) United States
(12) Patent Application Publication
(10) Pub. No.: US 2017/0369667 A1
(43) Pub. Date: Dec. 28, 2017

(54) FIBER REINFORCEMENT FOR ANISOTROPIC FOAMS

(71) Applicant: BASF SE, Ludwigshafen (DE)

(72) Inventors: Holger RUCKDÄSCHEL, St. Martin (DE); Rene ARBTER, Freinsheim (DE); Robert STEIN, Altrip (DE); Daniela LONGO-SCHEDEL, Sankt Augustin (DE); Tim DIEHLMANN, Obrigheim-Colgenstein (DE); Bangaru SAMPATH, Ludwigshafen (DE); Peter GUTMANN, Karlsruhe (DE); Alexandre TERRENOIRE, Ludwigshafen (DE); Markus HARTENSTEIN, Rülzheim (DE); Andreas KIRGIS, Mannheim (DE); Gregor DAUN, Neuckargemünd (DE); Marc Claude MARTIN, Lemförde (DE); Peter MERKEL, Zellertal (DE); Thomas KICIAK, Ludwigshafen (DE); Alessio MORINO, Castagneto Po (IT)

(21) Appl. No.: 15/538,788

(22) PCT Filed: Dec. 15, 2015
(86) PCT No.: PCT/EP2015/079803

§ 371 Date: Jun. 22, 2017

(30) Foreign Application Priority Data
Dec. 22, 2014 (EP) 14199628.0

(51) Int. Cl. C08J 9/00; B29C 44/56; B32B 27/06; B29C 47/90; C08J 5/04; B32B 5/24; C08J 9/12; C08J 9/14; B29C 44/50; C08J 3/22; B32B 5/20; B29C 44/34; B29L 31/08; B29L 9/00; B29K 105/12; B29K 105/04; B29K 67/00; B29K 25/00; B29C 47/00

(52) U.S. Cl. CPC C08J 9/0085; B29C 44/3446; B29C 44/352; B29C 44/569; B32B 27/065; B29C 47/90; C08J 5/043; B32B 5/245; C08J 9/127; C08J 9/149; B29C 44/505; C08J 3/226; B32B 5/20; C08J 9/122; B32B 2307/718; B32B 2307/706; B32B 2307/546; B32B 2307/542; B32B 2266/08; B32B 2266/0264; B32B 2266/0228; B32B 2260/046; B32B 2260/021; B29L 2031/08; B29L 2009/00; B29K 2105/12; B29K 2105/046; B29K 2067/003; B29K 2025/06; B29C 47/0019; B32B 2307/72; B32B 2603/00; C08J 2201/024; C08J 2201/03; C08J 2203/06; C08J 2203/12; C08J 2203/14; C08J 2203/202; C08J 2205/052; C08J 2325/06; C08J 2333/20; C08J 2335/06; C08J 2471/12; C08J 2467/02

(57) ABSTRACT

The invention relates to a molding composed of extruded foam, wherein at least one fiber (F) is present with a fiber region (FB2) within the molding and is surrounded by the extruded foam, while a fiber region (FB1) of the fiber (F) projects from a first side of the molding and a fiber region (FB3) of the fiber (F) projects from a second side of the molding, and the extruded foam is produced by an extrusion process comprising the following steps:
I) providing a polymer melt in an extruder,
II) introducing at least one blowing agent into the polymer melt provided in step I) to obtain a foamable polymer melt,
III) extruding the foamable polymer melt obtained in step II) from the extruder through at least one die aperture into an area at lower pressure, with expansion of the foamable polymer melt to obtain an expanded foam, and
IV) calibrating the expanded foam from step III) by conducting the expanded foam through a shaping tool to obtain the extruded foam.

The present invention relates a molding made of extruded foam, wherein at least one fiber (F) is partly within the molding, i.e. is surrounded by the extruded foam. The two ends of the respective fibers (F) that are not surrounded by the extruded foam thus each project from one side of the corresponding molding. The extruded foam is produced by an extrusion method in which the extruded foam is obtained by calibration through a shaping mold.

The present invention further provides a panel comprising at least one such molding and at least one further layer (S1). The present invention further provides processes for producing the moldings of the invention from extruded foam or the panels of the invention and for the use thereof, for example as rotor blade in wind turbines.

WO 2006/125561 relates to a process for producing a reinforced cellular material, wherein at least one hole extending from a first surface to a second surface of the cellular material is produced in the cellular material in a first process step. On the other side of the second surface of the cellular material, at least one fiber bundle is provided, said fiber bundle being drawn with a needle through the hole to the first side of the cellular material. However, before the needle takes hold of the fiber bundle, the needle is first pulled through the particular hole coming from the first side of the cellular material. In addition, the fiber bundle, on conclusion of the process according to WO 2006/125561, is partly within the cellular material, since it fills the corresponding hole, and the corresponding fiber bundle partly projects from the first and second surfaces of the cellular material on the respective sides.

By the process described in WO 2006/125561, it is possible to produce sandwich-like components comprising a core of said cellular material and at least one fiber bundle. Resin layers and fiber-reinforced resin layers may be applied to the surfaces of this core, in order to produce the actual sandwich-like component. Cellular materials used to form the core of the sandwich-like component may, for example, be polyvinyl chlorides or polyurethanes. Examples of useful fiber bundles include carbon fibers, nylon fibers, glass fibers or polyester fibers.

However, WO 2006/125561 does not disclose that extruded foams can also be used as cellular material for production of a core in a sandwich-like component. The sandwich-like components according to WO 2006/125561 are suitable for use in aircraft construction.

WO 2011/012587 relates to a further process for producing a core with integrated bridging fibers for panels made from composite materials. The core is produced by pulling the bridging fibers provided on a surface of what is called a “cake” made from lightweight material partly or completely through said cake with the aid of a needle. The “cake” may be formed from polyurethane foams, polyester foams, polyethylene terephthalate foams, polyvinyl chloride foams or a phenolic foam, especially from a polyurethane foam. The fibers used may in principle be any kind of single or multiple threads and other yarns.

The cores thus produced may in turn be part of a panel made from composite materials, wherein the core is surrounded on one or two sides by a resin matrix and combinations of resin matrices with fibers in a sandwich-like configuration. However, WO 2011/012587 does not disclose that extruded foams can be used for production of the corresponding core material.

WO 2012/138445 relates to a process for producing a composite core panel using a multitude of longitudinal strips of a cellular material having a low density. A twin-layer fiber mat is introduced between the individual strips, and this brings about bonding of the individual strips, with use of resin, to form the composite core panels. The cellular material having a low density that forms the longitudinal strips, according to WO 2012/138445, is selected from balsa wood, elastic foams and fiber-reinforced composite foams. The fiber mats introduced in twin-layer form between the individual strips may, for example, be a porous glass fiber mat. The resin used as adhesive may, for example, be a polyester, an epoxy resin or a phenolic resin, or a heat-activated thermoplastic, for example polypropylene or PET. However, WO 2012/138445 does not disclose that it is also possible to use an extruded foam as cellular material for the elongated strips. Nor is it disclosed therein that individual fibers or fiber bundles can be incorporated into the cellular material for reinforcement. According to WO 2012/138445, exclusively fiber mats that additionally constitute a bonding element in the context of adhesive bonding of the individual strips by means of resin to obtain the core material are used for this purpose.

GB-A 2 455 044 discloses a process for producing a multilayer composite article, wherein, in a first process step, a multitude of beads of thermoplastic material and a blowing agent are provided. The thermoplastic material is a mixture of polystyrene (PS) and polyphenylene oxide (PPO) comprising at least 20% to 70% by weight of PPO. In a second step the beads are expanded, and in a third step they are welded in a mold to form a closed-cell foam of the thermoplastic material to give a molding, the closed-cell foam assuming the shape of the mold. In the next process step, a layer of fiber-reinforced material is applied to the surface of the closed-cell foam, the attachment of the respective surfaces being conducted using an epoxy resin. However, GB-A 2 455 044 does not disclose that a fiber material can be introduced into the core of the multilayer composite article.

An analogous process and an analogous multilayer composite article (to those in GB-A 2 455 044) are also disclosed in WO 2009/047483. These multilayer composite articles are suitable, for example, for use of rotor blades (in wind turbines) or as ship's hulls.

U.S. Pat. No. 7,201,625 discloses a process for producing foam products and the foam products as such, which can be used, for example, in the sports sector as a surfboard. The core of the foam product is formed by a molded foam, for example based on a polystyrene foam. This molded foam is produced in a special mold, with an outer plastic skin surrounding the molded foam. The outer plastic skin may, for example, be a polyethylene film. However, U.S. Pat. No. 7,201,625 also does not disclose that fibers for reinforcement of the material may be present in the molded foam.

U.S. Pat. No. 6,767,623 discloses sandwich panels having a core layer of molded polypropylene foam based on particles having a particle size in the range from 2 to 8 mm and a bulk density in the range from 10 to 100 g/l. In addition, the sandwich panels comprise two outer layers of fiber-reinforced polypropylene, with the individual outer layers arranged around the core so as to form a sandwich. Still further layers may optionally be present in the sandwich panels for decorative purposes. The outer layers may comprise glass fibers or other polymer fibers.

EP-A 2 420 531 discloses extruded foams based on a polymer such as polystyrene in which at least one mineral filler having a particle size of ≦10 μm and at least one nucleating agent are present. These extruded foams are notable for their improved stiffness. Additionally described is a corresponding extrusion process for producing such extruded foams based on polystyrene. The extruded foams may have closed cells. However, EP-A 2 480 531 does not state that the extruded foams comprise fibers.

WO 2005/056653 relates to molded foams formed from expandable polymer beads comprising filler. The molded foams are obtainable by welding prefoamed foam beads formed from expandable thermoplastic polymer beads comprising filler, the molded foam having a density in the range from 8 to 300 g/l. The thermoplastic polymer beads especially comprise a styrene polymer. The fillers used may be pulverulent inorganic substances, metal, chalk, aluminum hydroxide, calcium carbonate or alumina, or inorganic substances in the form of beads or fibers, such as glass beads, glass fibers or carbon fibers.

U.S. Pat. No. 3,030,256 relates to laminated panels which have been produced by using fibers to reinforce a core that has been produced from a foam or an expanded polymer. Materials described for the core are expanded and extruded polystyrene, and also phenols, epoxides and polyurethanes. For introduction of the fibers, a needle is used to produce a hole from the first side of the core to the second side of the core, and the same needle is used to pull a fiber bundle through the hole from the second side to the first side, such that the fiber bundle is partly within the core and partly projects from the first and second sides. The fiber material is introduced into the core at an angle of 0° relative to the thickness direction of the core.

The object underlying the present invention is that of providing novel fiber-reinforced moldings or panels.

This object is achieved in accordance with the invention by a molding made of extruded foam, in which at least one fiber (F) is present with a fiber region (FB2) within the molding and is surrounded by the extruded foam, while a fiber region (FB1) of the fiber (F) projects from a first side of the molding and a fiber region (FB2) of the fiber (F) projects from a second side of the molding, and the extruded foam is produced by an extrusion process comprising the following steps:
I) providing a polymer melt in an extruder,
II) introducing at least one blowing agent into the polymer melt provided in step I) to obtain a foamable polymer melt,
III) extruding the foamable polymer melt obtained in step II) from the extruder through at least one die aperture into an area at lower pressure, with expansion of the foamable polymer melt to obtain an expanded foam, and
IV) calibrating the expanded foam from step III) by conducting the expanded foam through a shaping tool to obtain the extruded foam,
   wherein the fiber (F) has been introduced into the extruded foam at an angle α of 10° to 70° relative to the thickness direction (d) of the molding.

The present invention further provides a molding made of extruded foam, in which at least one fiber (F) is present with a fiber region (FB2) within the molding and is surrounded by the extruded foam, while a fiber region (FB1) of the fiber (F) projects from a first side of the molding and a fiber region (FB2) of the fiber (F) projects from a second side of the molding, and the extruded foam is produced by an extrusion process comprising the following steps:
I) providing a polymer melt in an extruder,
II) introducing at least one blowing agent into the polymer melt provided in step I) to obtain a foamable polymer melt,
III) extruding the foamable polymer melt obtained in step II) from the extruder through at least one die aperture into an area at lower pressure, with expansion of the foamable polymer melt to obtain an expanded foam, and
IV) calibrating the expanded foam from step III) by conducting the expanded foam through a shaping tool to obtain the extruded foam.

The details and preferences which follow apply to both embodiments of the inventive molding made from extruded foam.

The moldings of the invention advantageously feature low resin absorption with simultaneously good interfacial binding. This effect is important especially when the moldings of the invention are being processed further to give the panels of the invention.

Since, in a preferred embodiment of the molding, the extruded foam comprises cells and these are anisotropic to an extent of at least 50%, preferably to an extent of at least 80% and more preferably to an extent of at least 90%, the mechanical properties of the extruded foam and hence also those of the molding are anisotropic, which is particularly advantageous for use of the molding of the invention, especially for rotor blades, in wind turbines, in the transport sector, in the construction sector, in automobile construction, in shipbuilding, in rail vehicle construction, in container construction, in sanitary facilities and/or in aerospace.

The moldings of the invention have particularly high compressive strength in at least one direction because of their anisotropy. They additionally feature a high closed-cell content and good vacuum stability.

Since, in a further preferred embodiment, the at least one fiber (F) is introduced into the extruded foam at an angle ε≦60° relative to the largest dimension of the anisotropic cells, a smaller number of cells is destroyed on introduction of the at least one fiber (F) than in the case of the foams described in the prior art, which likewise has a positive effect on the resin absorption of the molding on processing to give a panel.

Moreover, because of the anisotropy of the cells, the sewing resistance in one inventive embodiment of a process for producing moldings is lower than in the case of foams described in the prior art. This enables a faster sewing process; in addition, the service life of the needle is prolonged. This makes the process of the invention particularly economically viable.

A further improvement in binding with simultaneously reduced resin absorption is enabled in accordance with the invention by the fiber reinforcement of the extruded foams in the moldings of the invention or the panels that result therefrom. According to the invention, the fibers (individually or preferably in the form of fiber bundles) can advantageously be introduced into the extruded foam at first in dry form and/or by mechanical processes. The fibers or fiber bundles are not laid down flush with the respective extruded foam surfaces, but with an excess, and hence enable improved binding or direct connection to the corresponding outer plies in the panel of the invention. This is the case especially when the outer ply applied to the molding of the invention, in accordance with the invention, is at least one further layer (S1) to form a panel. Preference is given to applying two layers (S1), which may be the same or different. More preferably, two identical layers (S1), especially two identical fiber-reinforced resin layers, are applied to opposite sides of the molding of the invention to form a panel of the invention. Such panels are also referred to as “sandwich materials”, in which case the molding of the invention can also be referred to as “core material”.

The panels of the invention are thus notable for low resin absorption in conjunction with good peel strength. It is additionally possible via the anisotropy of the cells and hence the mechanical properties of the foam to control crease resistance. Advantageously, the extruded foam is used in such a way that the mechanical properties are at their highest in thickness direction of the panel and hence maximum crease resistances can be achieved. Moreover, high strength and stiffness properties can be established in a controlled manner via the choice of fiber types and the proportion and arrangement thereof. The effect of low resin absorption is important because a common aim in the case of use of such panels (sandwich materials) is that the structural properties should be increased with minimum weight. In the case of use of fiber-reinforced outer plies, for example, as well as the actual outer plies and the molding (sandwich core), the resin absorption of the molding (core material) makes a contribution to the total weight. However, the moldings of the invention or the panels of the invention can reduce the resin absorption, which can save weight and costs.

A particular advantage in one embodiment of the moldings of the invention can be considered to be the closed surface of the extruded foam. After the calibration of the extruded foam, there is generally a sealed (closed) surface with high surface quality, which is notable for minimum resin absorption and a density gradient proceeding from the core of the extruded foam to the surface, with increasing density from the core of the extruded foam to its surface. Especially through combination with the fibers introduced to obtain the moldings of the invention, it is thus possible to achieve minimum weight coupled with maximum mechanical properties.

A further advantage of the moldings or panels of the invention is considered to be that the use of extruded foams and the associated production makes it relatively simple to incorporate integrated structures such as slots or holes on the surfaces of the moldings and to process the moldings further. The continuous manufacture allows structures to be integrated directly in the process by shaping steps such as thermoforming or material-removing processing. In the case of use of such moldings (core materials), structures of this kind are frequently introduced, for example, into curved structures (deep slots) for draping, for improvement of processability by liquid resin processes such as vacuum infusion (holes), and for acceleration of the processing operation mentioned (shallow slots).

In addition, further layers (S2) can be applied to the extruded foam in the course of or after manufacture. Layers of this kind improve the overall integrity of the extruded foam or of the molding of the invention.

Extruded foams are generally produced from thermoplastic polymers. As a result, both the extruded foams and the moldings can be formed to the desired geometries by thermoforming and hence with avoidance of material-removing processing steps.

Further improvements/advantages can be achieved in that the fibers are introduced into the extruded foam at an angle α in the range from 10° to 70° in relation to the thickness direction (d) of the extruded foam, more preferably of 30° to 50°. Generally, the introduction of the fibers at an angle of 0° to <90° is performable industrially in an automated manner.

Additional improvements/advantages can be achieved when the fibers are introduced into the extruded foam not only in a parallel manner, but further fibers are also introduced at an angle to one another which is preferably in the range from >0 to 180°.

This additionally achieves a controlled improvement in the mechanical properties of the molding of the invention in different directions.

It is likewise advantageous when the (outer) resin layer in the panels of the invention is applied by liquid injection methods or liquid infusion methods, in which the fibers can be impregnated with resin during processing and the mechanical properties improved. In addition, cost savings are possible.

The present invention is specified further hereinafter.

According to the invention, the molding comprises an extruded foam and at least one fiber (F).

The extruded foam is produced (or is producible or has been produced) by an extrusion process comprising the following steps:
I) providing a polymer melt in an extruder,
II) introducing at least one blowing agent into the polymer melt provided in step I) to obtain a foamable polymer melt,
III) extruding the foamable polymer melt obtained in step II) from the extruder through at least one die aperture into an area at lower pressure, with expansion of the foamable polymer melt to obtain an expanded foam, and
IV) calibrating the expanded foam from step III) by conducting the expanded foam through a shaping tool to obtain the extruded foam.

Suitable methods for provision of the polymer melt in the extruder in step I) are in principle all methods known to those skilled in the art; for example, the polymer melt can be provided in the extruder by melting an already ready-polymerized polymer. The polymer can be melted directly in the extruder; it is likewise possible to feed the polymer to the extruder in molten form and thus to provide the polymer melt in the extruder in step I). It is likewise possible that the polymer melt is provided in step I) in that the corresponding monomers required for preparation of the polymer of the polymer melt react with one another in the extruder and hence the polymer melt is provided.

A polymer melt is understood in the present context to mean that the polymer is above the melting temperature (T_{M}) in the case of semicrystalline polymers or the glass transition temperature (T_{G}) in the case of amorphous polymers.

Typically, the temperature of the polymer melt in process step I) is in the range from 100 to 450° C., preferably in the range from 150 to 350° C. and especially preferably in the range from 160 to 300° C.

In step II), at least one blowing agent is introduced into the polymer melt provided in step I). Methods for this purpose are known as such to those skilled in the art.

Suitable blowing agents are selected, for example, from the group consisting of carbon dioxide, alkanes such as propane, isobutane and pentane, alcohols such as methanol, ethanol, 1-propanol, 2-propanol, 1-butanol, 2-butanol, 2-methylpropanol and tert-butanol, ethers such as dimethyl ether, ketones such as acetone and methyl ethyl ketone, halogenated hydrocarbons such as hydrofluoropropene, water, nitrogen and mixtures of these.

In step II), the foamable polymer melt is thus obtained. The foamable polymer melt comprises typically in the range from 1% to 15% by weight of the at least one blowing agent, preferably in the range from 2% to 10% by weight and especially preferably in the range from 3% to 8% by weight, based in each case on the total weight of the foamable polymer melt.

The pressure in the extruder in step II) is typically in the range from 20 to 500 bar, preferably in the range from 50 to 400 bar and especially preferably in the range from 60 to 300 bar.

In step III), the foamable polymer melt obtained in step II) is extruded through at least one die aperture from the extruder into an area at lower pressure, with expansion of the foamable polymer melt to obtain the expanded foam.

Methods of extrusion of the foamable polymer melt are known as such to those skilled in the art.

Suitable die apertures for the extrusion of the foamable polymer melt are all those known to the person skilled in the art. The die aperture may have any desired shape; for example, it may be rectangular, circular, elliptical, square or hexagonal. Preference is given to rectangular slot dies and circular round dies.

In one embodiment, the foamable polymer melt is extruded through exactly one die aperture, preferably through a slot die. In a further embodiment, the foamable polymer melt is extruded through a multitude of die apertures, preferably circular or hexagonal die apertures, to obtain a multitude of strands, the multitude of strands being combined immediately after emergence from the die apertures to form the expanded foam. The multitude of strands can also be combined only in step IV) by passing through the shaping tool.

Preferably, the at least one die aperture is heated. Especially preferably, the die aperture is heated at least to the glass transition temperature (T_{G}) of the polymer present in the polymer melt provided in step I) when the polymer is an amorphous polymer, and at least to the melting temperature (T_{M}) of the polymer present in the polymer melt provided in step I) when the polymer melt is a semicrystalline polymer; for example, the temperature of the die aperture is in the range from 80 to 400° C., preferably in the range from 100 to 350° C. and especially preferably in the range from 110 to 300° C.

The foamable polymer melt is extruded in step III) into an area at lower pressure. The pressure in the area at lower pressure is typically in the range from 0.05 to 5 bar, preferably in the range from 0.5 to 1.5 bar.

The pressure at which the foamable polymer melt is extruded out of the die aperture in step III) is typically in the range from 20 to 600 bar, preferably in the range from 40 to 300 bar and especially preferably in the range from 50 to 250 bar.

In step IV), the expanded foam from step III) is calibrated by conducting the expanded foam through a shaping tool to obtain the extruded foam.

The calibration of the expanded foam determines the outer shape of the extruded foam obtained in step IV). Methods of calibration are known as such to those skilled in the art.

The shaping tool may be disposed directly at the die aperture. It is likewise possible that the shaping tool is disposed at a distance from the die aperture.

Shaping tools for calibration of the expanded foam are known as such to those skilled in the art. Suitable shaping tools include, for example, sheet calibrators, roller takeoffs, mandrel calibrators, chain takeoffs and belt takeoffs. In order to reduce the coefficient of friction between the shaping tools and the extruded foam, the tools can be coated and/or heated.

The calibration in step IV) thus fixes the geometric shape of the cross section of the extruded foam of the invention in at least one dimension. Preferably, the extruded foam has a virtually orthogonal cross section. If the calibration is partly undertaken only in particular directions, the extruded foam may depart from the ideal geometry at the free surfaces. The thickness of the extruded foam is determined firstly by the die aperture, and secondly also by the shaping tool; the same applies to the width of the extruded foam.

Based on an orthogonal system of coordinates, the length of the foam thus obtained is referred to as the x direction, the width as the y direction and the thickness as the z direction. The x direction corresponds to the extrusion direction of the foam.

In addition, it is preferable in accordance with the invention that
i) the polymer melt provided in step I) comprises at least one additive, and/or
ii) at least one additive is added during step II) to the polymer melt and/or between step II) and step III) to the foamable polymer melt, and/or
iii) at least one additive is applied during step III) to the expanded foam and/or during step IV) to the expanded foam, and/or
iv) at least one layer (S2) is applied to the extruded foam during and/or directly after step IV), and/or
v) the following process step is conducted after step IV):
   V) material-removing processing of the extruded foam obtained in step IV).

Suitable additives are in principle all additives known to those skilled in the art, for example nucleating agents, flame retardants, dyes, process stabilizers, processing aids, light stabilizers and pigments.

With regard to layer (S2), which in one embodiment is applied to the extruded foam, the details and preferences described further down are applicable.

Suitable methods for material-removing processing, in step V), of the extruded foam obtained in step IV) are in principle all methods known to those skilled in the art. For example, the extruded foam can be subjected to material-removing processing by sawing, milling, drilling or planing. When the extruded foam is a thermoplastic extruded foam, thermoforming is additionally possible, by means of which it is possible to avoid material-removing processing with cutting losses and damage to the fibers (F).

In one embodiment of the present invention, at least two of the extruded foams obtained in step IV) and/or in step V) are bonded to one another to obtain a multilaminar extruded foam. “Multilaminar” in the present context is understood to mean an at least dilaminar extruded foam; the extruded foam may likewise, for example, be tri-, tetra- or pentalaminar. It will be apparent to the person skilled in the art that a dilaminar extruded foam is obtained by the combining of two extruded foams obtained in step IV) and/or in step V), a trilaminar extruded foam by the combining of three of the extruded foams obtained, and so forth. The combining of the extruded foams obtained with one another is also referred to as “joining”. Suitable methods for this purpose are known as such to those skilled in the art. For example, the extruded foams obtained can be combined with one another by bonding and/or thermal welding. It will be apparent that the at least dilaminar extruded foam has a greater thickness than the at least two extruded foams obtained in step IV) and/or in step V).

The extruded foam of the invention may have any desired dimensions.

The extruded foam produced in accordance with the invention typically has a thickness (z direction) in the range from 4 to 200 mm, preferably in the range from 5 to 60 mm, a length (x direction) of at least 200 mm, preferably of at least 400 mm, and a width (y direction) of at least 200 mm, preferably of at least 400 mm.

The extruded foam typically has a length (x direction) of not more than 4000 mm, preferably of not more than 2500 mm, and/or a width (y direction) of not more than 4000 mm, preferably of not more than 2500 mm.

Extruded foams are known as such to those skilled in the art. In one embodiment, the extruded foam is based, for example, on at least one polymer selected from polystyrene, polyester, polyphenylene oxide, a copolymer prepared from phenylene oxide, a copolymer prepared from styrene, polyaryl ether sulfone, polyphenylene sulfide, polyaryl ether ketones, polypropylene, polyethylene, polyamide, polyamide imide, polyether imide, polycarbonate, polyacrylate, polylactic acid, polyvinyl chloride, or a mixture thereof, the polymer preferably being selected from polystyrene, polyphenylene oxide, a mixture of polystyrene and polyphenylene oxide, polyethylene terephthalate, polycarbonate, polyether sulfone, polysulfone, polyether imide, a copolymer prepared from styrene, or a mixture of copolymers prepared from styrene. More preferably, the polymer is polystyrene, a mixture of polystyrene and poly(2,6-dimethylphenylene oxide), a mixture of a styrene-maleic anhydride polymer and a styrene-acrylonitrile polymer, or a styrene-maleic anhydride polymer (SMA).

Also suitable as extruded foam are thermoplastic elastomers. Thermoplastic elastomers are known as such to those skilled in the art.

Polyphenylene oxide is preferably poly(2,6-dimethylphenylene ether), which is also referred to as poly(2,6-dimethylphenylene oxide).

Suitable copolymers prepared from phenylene oxide are known to those skilled in the art. Suitable comonomers for phenylene oxide are likewise known to those skilled in the art.

A copolymer prepared from styrene preferably has, as comonomer, a monomer selected for styrene from α-methylstyrene, ring-halogenated styrenes, ring-alkylated styrenes, acrylonitrile, acrylic esters, methacrylic esters, N-vinyl compounds, maleic anhydride, butadiene, divinylbenzene and butanediol diacrylate.

Preference is also given to a molding of the invention, wherein the extruded foam comprises cells, where
i) at least 50%, preferably at least 80% and more preferably at least 90% of the cells are anisotropic, and/or
ii) the ratio of the largest dimension (a direction) to the smallest dimension (c direction) of at least 50%, preferably at least 80% and more preferably at least 90% of the cells is 1.05, preferably in the range from 1:1 to 10, especially preferably in the range from 1.2 to 5, and/or
iii) the mean size of the smallest dimension (c direction) of at least 50%, preferably at least 80% and more preferably at least 90% of the cells is less than 0.5 mm, preferably less than 0.2 mm, and/or
iv) at least 50%, preferably at least 80% and more preferably at least 90% of the cells are orthotropic or transversely isotropic, and/or
v) at least 50%, preferably at least 80% and more preferably at least 90% of the cells, based on their largest dimension (a direction), are aligned at an angle γ of ≦45°, preferably of ≦30° and more preferably of ≦5° relative to the thickness direction (d) of the molding, and/or
vi) the extruded foam has a closed-cell content of at least 80%, preferably at least 95%, more preferably at least 98%, and/or
vii) the fibers (F) are at an angle ε of ≦60°, preferably ≦50°, relative to the largest dimension (a direction) of at least 50%, preferably at least 80% and more preferably at least 90% of the cells of the extruded foam.

In an alternative embodiment, preference is given to a molding of the invention that fulfills at least one of the above-described options i) to vii), except that, according to option v), at least 50%, preferably at least 80% and more preferably at least 90% of the cells, based on their largest dimension (a direction), are aligned at an angle γ in the range from 50° to 130°, preferably in the range from 70° to 110° and more preferably in the range from 85° to 95°, relative to the thickness direction (d) of the molding.

An anisotropic cell has different dimensions in different spatial directions. The largest dimension of the cell is referred to as “a direction” and the smallest dimension as “c direction”; the third dimension is referred to as “b direction”.

The mean size of the smallest dimension (c direction) of at least 50%, preferably at least 80% and more preferably at least 90% of the cells is typically in the range from 0.01 to 1 mm, preferably in the range from 0.02 to 0.5 mm and especially in the range from 0.02 to 0.3 mm.

The mean size of the largest dimension (a direction) of at least 50%, preferably at least 80% and more preferably at least 90% of the cells is typically in the region of not more than 20 mm, preferably in the range from 0.01 to 5 mm, especially in the range from 0.03 to 1 mm and more preferably between 0.03 and 0.5 mm.

The dimensions of the cells can be determined, for example, by means of light micrographs or scanning electron micrographs.

An orthotropic cell is understood to mean a special case of an anisotropic cell. Orthotropic means that the cells have three planes of symmetry. In the case that the planes of symmetry are oriented orthogonally to one another, based on an orthogonal system of coordinates, the dimensions of the cell are different in all three spatial directions, i.e. in a direction, in b direction and in c direction.

Transversely isotropic means that the cells have three planes of symmetry. However, the cells are invariant with respect to rotation about an axis which is the axis of intersection of two planes of symmetry. In the case that the planes of symmetry are oriented orthogonally to one another, only the dimension of the cell in one spatial direction is different than the dimension of the cell in the two other directions. For example, the dimension of the cell in a direction is different than that in b direction and that in c direction, and the dimensions of the cell in b direction and those in c direction are the same.

The closed-cell content of the extruded foam is determined according to DIN ISO 4590 (as per German version 2003). The closed-cell content describes the proportion by volume of closed cells in the total volume of the extruded foam.

The anisotropic properties of the cells of the extruded foam result from the extrusion process of the invention. By virtue of the foamable polymer melt being extruded in step III) and the expanded foam thus obtained being calibrated in step IV), the extruded foam thus produced typically obtains anisotropic properties which result from the anisotropic cells. The properties are additionally affected by the expansion properties and the takeoff parameters as well. If the foamable polymer melt expands very significantly, for example, to obtain the expanded foam, it expands especially in x direction, i.e. in length, which preferably leads to alignment of the a direction of the cells in the range from 50 to 130° relative to the thickness direction (d).

If the expanded foam is taken off rapidly, for example, i.e. moved quickly through the shaping tool, the a direction of the cells is preferably aligned in the range from 50° to 130° relative to the thickness direction (d).

If the properties of the extruded foam are anisotropic, this means that the properties of the extruded foam differ in different spatial directions. For example the compressive strength of the extruded foam in thickness (z direction) may be different than in length (x direction) and/or in width (y direction).

Preference is further given to a molding of the invention in which
i) at least one of the mechanical properties, preferably all the mechanical properties, of the extruded foam is/are anisotropic, preferably orthotropic or transversely isotropic, and/or
ii) at least one of the elastic moduli, preferably all the elastic moduli, of the extruded foam behave(s) in the manner of an anisotropic, preferably orthotropic or transversely isotropic, material, and/or
iii) the ratio of the compressive strength of the extruded foam in thickness (z direction) to the compressive strength of the extruded foam in length (x direction) and/or the ratio of the compressive strength of the extruded foam in thickness (z direction) to the compressive strength of the extruded foam in width (y direction) is ≧1.1, preferably ≧1.5, especially preferably between 2 and 10.

Mechanical properties are understood to mean all mechanical properties that are known to those skilled in the art in extruded foams, for example strength, stiffness or elasticity, ductility and toughness.

The elastic moduli are known as such to those skilled in the art. The elastic moduli include, for example, the modulus of elasticity, the compression modulus, the torsion modulus and the shear modulus.

“Orthotropic” in relation to the mechanical properties or the elastic moduli means that the material has three planes of symmetry. In the case that the planes of symmetry are oriented orthogonally to one another, an orthogonal system of coordinates is applicable. The mechanical properties or the elastic moduli of the extruded foam thus differ in all three spatial directions, x direction, y direction and z direction.

“Transversely isotropic” in relation to the mechanical properties or the elastic moduli means that the material has three planes of symmetry and the moduli are invariant with respect to rotation about an axis which is the axis of intersection of two planes of symmetry. In the case that the planes of symmetry are oriented orthogonally to one another, the mechanical properties or the elastic moduli of the extruded foam are different in one spatial direction than those in the two other spatial directions, but are the same in the two other spatial directions. For example, the mechanical properties or the elastic moduli in z direction differ from those in x direction and in y direction; those in x direction and in y direction are the same.

The compressive strength of the extruded foam of the molding is determined according to DIN EN ISO 844 (as per German version October 2009).

The compressive strength of the extruded foam in thickness (z direction) is typically in the range from 0.05 to 5 MPa, preferably in the range from 0.1 to 2 MPa, more preferably in the range from 0.1 to 1 MPa.

The compressive strength of the extruded foam in length (x direction) and/or in width (y direction) is typically in the range from 0.05 to 5 MPa, preferably in the range from 0.1 to 2 MPa, more preferably in the range from 0.1 to 1 MPa.

The fiber (F) present in the molding is a single fiber or a fiber bundle, preferably a fiber bundle. Suitable fibers (F) are all materials known to those skilled in the art that can form fibers. For example, the fiber (F) is an organic, inorganic, metallic or ceramic fiber or a combination thereof, preferably a polymeric fiber, basalt fiber, glass fiber, carbon fiber or natural fiber, especially preferably a polyaramid fiber, glass fiber, basalt fiber or carbon fiber; a polymeric fiber is preferably a fiber of polyester, polyamide, polyaramid, polyethylene, polyurethane, polyvinyl chloride, polyimide and/or polyamide imide; a natural fiber is preferably a fiber of sisal, hemp, flax, bamboo, coconut and/or jute.

In one embodiment, fiber bundles are used. The fiber bundles are composed of several single fibers (filaments). The number of single fibers per bundle is at least 10, preferably 100 to 100 000 and more preferably 300 to 10 000 in the case of glass fibers and 1000 to 50 000 in the case of carbon fibers, and especially preferably 500 to 5000 in the case of glass fibers and 2000 to 20 000 in the case of carbon fibers.

According to the invention, the at least one fiber (F) is present with a fiber region (FB2) within the molding and is surrounded by the extruded foam, while a fiber region (FB1) of the fiber (F) projects from a first side of the molding and a fiber region (FB3) of the fiber (F) projects from a second side of the molding.

The fiber region (FB1), the fiber region (FB2) and the fiber region (FB3) may each account for any desired proportion of the total length of the fiber (F). In one embodiment, the fiber region (FB1) and the fiber region (FB3) each independently account for 1% to 45%, preferably 2% to 40% and more preferably 5% to 30%, and the fiber region (FB2) for 10% to 98%, preferably 20% to 96% and more preferably 40% to 90%, of the total length of the fiber (F).

In a further preferred embodiment, the first side of the molding from which the fiber region (FB1) of the fiber (F) projects is opposite the second side of the molding from which the fiber region (FB3) of the fiber (F) projects.

The fiber (F) has been introduced into the molding at an angle α of 10° to 70° relative to thickness direction (d) of the molding or to the orthogonal (of the surface) of the first side of the molding. Preferably, the fiber (F) has been introduced into the extruded foam at an angle α of 30° to 60°, preferably of 30° to 50°, even more preferably of 30° to 45° and especially of 45° relative to the thickness direction (d) of the molding.

In a further embodiment of the invention, the angle α can assume any desired values from 0° to 90°. For example, the fiber (F) in that case has been introduced into the extruded foam at an angle α of 0° to 60°, preferably of 0° to 50°, more preferably 0° to 15° or of 30° to 50°, even more preferably of 30° to 45° and especially of 45° relative to the thickness direction (d) of the molding.

In a further embodiment, at least two fibers (F) are introduced at two different angles α, α₁ and α₂, where the angle α₁ is preferably in the range from 0° to 15° and the second angle α₂ is preferably in the range from 30° to 50°; especially preferably, α₁ is in the range from 0° to 5° and α₂ in the range from 40° to 50°.

Preferably, all fibers (F) have been introduced into the extruded foam at an angle α in the range from 10° to 70°, preferably from 30° to 60°, especially preferably from 30° to 50°, even more preferably from 30° to 45° and most preferably of 45° relative to the thickness direction (d) of the molding.

It is additionally preferable that no further fiber has been introduced into the extruded foam apart from the at least one fiber (F).

Preferably, a molding of the invention comprises a multitude of fibers (F), preferably as fiber bundles, and/or comprises more than 10 fibers (F) or fiber bundles per m², preferably more than 1000 per m², more preferably 4000 to 40 000 per m². Preferably, all fibers (F) in the molding of the invention have the same angle α or at least approximately the same angle (difference of not more than ⁺/₋5°, preferably ⁺/₋2°, more preferably ⁺/₋1°).

All fibers (F) may be present parallel to one another in the molding. It is likewise possible and preferable in accordance with the invention that two or more fibers (F) are present at an angle β to one another in the molding. The angle β is understood in the context of the present invention to mean the angle between the orthogonal projection of a first fiber (F1) onto the surface of the first side of the molding and the orthogonal projection of a second fiber (F2) onto the surface of the molding, both fibers having been introduced into the molding.

The angle β is preferably in the range of β=360°/n where n is an integer. Preferably, n is in the range from 2 to 6, more preferably in the range from 2 to 4. For example, the angle β is 90°, 120° or 180°. In a further embodiment, the angle β is in the range from 80° to 100°, in the range from 110° to 130° or in the range from 170° to 190°. In a further embodiment, more than two fibers (F) have been introduced at an angle β, for example three or four fibers (F). These three or four fibers (F) may each have two different angles β, β₁ and β₂, to the two adjacent fibers. Preferably, all the fibers (F) have the same angles β=β₁=β₂ to the two adjacent fibers (F). For example, the angle β is 90°, in which case the angle β₁ between the first fiber (F1) and the second fiber (F2) is 90°, the angle β₂ between the second fiber (F2) and third fiber (F3) is 90°, the angle β₃ between the third fiber and fourth fiber (F4) is 90°, and the angle β₄ between the fourth fiber (F4) and the first fiber (F1) is likewise 90°. The angles β between the first fiber (F1) (reference) and the second fiber (F2), third fiber (F3) and fourth fiber (F4) are then, in the clockwise sense, 90°, 180° and 270°. Analogous considerations apply to the other possible angles.

The first fiber (F1) in that case has a first direction, and the second fiber (F2) arranged at an angle β to the first fiber (F1) has a second direction. Preferably, there is a similar number of fibers in the first direction and in the second direction. “Similar” in the present context is understood to mean that the difference between the number of fibers in each direction relative to the other direction is <30%, more preferably <10% and especially preferably <2%.

The fibers or fiber bundles may be introduced in irregular or regular patterns. Preference is given to the introduction of fibers or fiber bundles in regular patterns. “Regular patterns” in the context of the present invention is understood to mean that all fibers are aligned parallel to one another and that at least one fiber or fiber bundle has the same distance (a) from all directly adjacent fibers or fiber bundles. Especially preferably, all fibers or fiber bundles have the same distance from all directly adjacent fibers or fiber bundles.

In a further preferred embodiment, the fibers or fiber bundles are introduced such that they, based on an orthogonal system of coordinates, where the thickness direction (d) corresponds to z direction, each have the same distance (aₓ) from one another in the x direction and the same distance (a_{y}) in the y direction. Especially preferably, they have the same distance (a) in x direction and in y direction, where a=aₓ=a_{y}.

If two or more fibers (F) are at an angle β to one another, the first fibers (F1) that are parallel to one another preferably have a regular pattern with a first distance (a₁), and the second fibers (F2) that are parallel to one another and are at an angle β to the first fibers (F1) preferably have a regular pattern with a second distance (a₂). In a preferred embodiment, the first fibers (F1) and the second fibers (F2) each have a regular pattern with a distance (a). In that case, a=a₁=a₂.

If fibers or fiber bundles are introduced into the extruded foam at an angle β to one another, it is preferable that the fibers or fiber bundles follow a regular pattern in each direction.

In a preferred embodiment of the molding according to the present invention,
i) the surface of at least one side of the molding has at least one recess, the recess preferably being a slot or a hole, and at least one recess more preferably being produced on the surface of at least one side of the molding after the performance of step IV) of the extrusion process, and/or
ii) the surface of at least one side of the molding has at least one recess, the recess preferably being a slot or a hole, and at least one recess more preferably being produced on the surface of at least one side of the molding after the performance of step V) of the extrusion process.

FIG. 1 shows a schematic diagram of a preferred embodiment of the molding of the invention made from extruded foam (1) in a perspective view. (2) represents (the surface of) a first side of the molding, while (3) represents a second side of the corresponding molding. As further apparent from FIG. 1, the first side (2) of the molding is opposite the second side (3) of this molding. The fiber (F) is represented by (4). One end of this fiber (4a) and hence the fiber region (FB1) projects from the second side (2) of the molding, while the other end (4b) of the fiber, which constitutes the fiber region (FB3), projects from the second side (3) of the molding. The middle fiber region (FB2) is within the molding and is thus surrounded by the extruded foam.

In FIG. 1, the fiber (4) which is, for example, a single fiber or a fiber bundle, preferably a fiber bundle, is at an angle α relative to thickness direction (d) of the molding or to the orthogonal (of the surface) of the first side (2) of the molding. The angle α is 10° to 70°, preferably 30° to 60°, more preferably 30° to 50°, even more preferably 30° to 45°, especially 45°. For the sake of clarity, FIG. 1 shows just a single fiber (F).

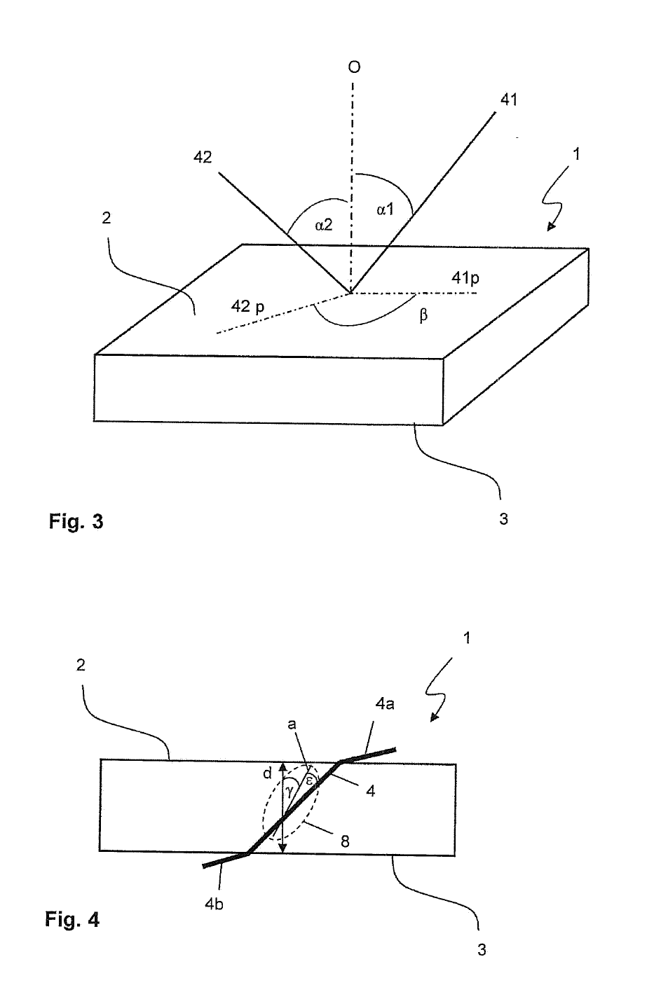

FIG. 3 shows, by way of example, a schematic diagram of some of the different angles. The molding made from extruded foam (1) shown in FIG. 3 comprises a first fiber (41) and a second fiber (42). In FIG. 3, for better clarity, only the fiber region (FB1) that projects from the first side (2) of the molding is shown for the two fibers (41) and (42). The first fiber (41) forms a first angle α (α1) relative to the orthogonal (O) of the surface of the first side (2) of the molding. The second fiber (42) forms a second angle α (α2) relative to the orthogonal (O) of the surface of the first side (2). The orthogonal projection of the first fiber (41) onto the first side (2) of the molding (41p) forms the angle β with the orthogonal projection of the second fiber (42) onto the first side (2) of the molding (42p).

FIG. 4 shows, by way of example, a schematic diagram of the different angles based on the largest dimension (a direction) of the cell (8). The molding made from extruded foam (1) shown in FIG. 4 comprises a fiber (4) and a cell (8). For the sake of clarity, FIG. 4 shows only one fiber (4) and one cell (8). It will be apparent that the molding typically comprises more than one cell (8). The largest dimension (a) of the cell (8) has an angle γ of ≦45°, preferably of ≦30° and more preferably of ≦5° relative to the thickness direction (d) of the molding. The fiber (4) has been introduced into the extruded foam at an angle ε of ≦60°, preferably ≦50°, relative to the largest dimension (a) of the cell (8).

The present invention also provides a panel comprising at least one molding of the invention and at least one further layer (S1). A “panel” may in some cases also be referred to among specialists as “sandwich”, “sandwich material”, “laminate” and/or “composite article”.

In a preferred embodiment of the panel, the panel has two layers (S1), and the two layers (S1) are each mounted on a side of the molding opposite the respective other side in the molding.

In one embodiment of the panel of the invention, the layer (S1) comprises at least one resin, the resin preferably being a reactive thermoset or thermoplastic resin, the resin more preferably being based on epoxides, acrylates, polyurethanes, polyamides, polyesters, unsaturated polyesters, vinyl esters or mixtures thereof, and the resin especially being an amine-curing epoxy resin, a latently curing epoxy resin, an anhydride-curing epoxy resin or a polyurethane formed from isocyanates and polyols. Resin systems of this kind are known to those skilled in the art, for example from Penczek et al. (Advances in Polymer Science, 184, p. 1-95, 2005), Pham et al. (Ullmann's Encyclopedia of Industrial Chemistry, vol. 13, 2012), Fahnler (Polyamide, Kunststoff Handbuch 3/4, 1998) and Younes (WO12134878 A2).

Preference is also given in accordance with the invention to a panel in which)
i) the fiber region (FB1) of the fiber (F) is in partial or complete contact, preferably complete contact, with the first layer (S1), and/or
ii) the fiber region (FB3) of the fiber (F) is in partial or complete contact, preferably complete contact, with the second layer (S1), and/or
iii) the panel has at least one layer (S2) between at least one side of the molding and at least one layer (S1), the layer (S2) preferably being composed of two-dimensional fiber materials or polymeric films, more preferably of glass fibers or carbon fibers in the form of webs, scrims or weaves, and/or
iv) the at least one layer (S1) comprises a resin and the extruded foam of the molding of the panel has a surface resin absorption of ≦2000 g/m², preferably of 51000 g/m², more preferably of ≦500 g/m², most preferably of ≦100 g/m², and/or
v) the at least one layer (S1) comprises a resin and the panel has a peel resistance of ≧200 J/m², preferably of ≧500 J/m², more preferably of ≧2000 J/m².

Particularly low resin absorptions are achieved for the extruded foam, for example, by sealing the surface or shaping the extruded foam by thermal cutting.

Analogously, in the moldings of the invention, it is possible to directly use the closed surface of the extruded foam after manufacture. After the calibration of the extruded foam, there is generally a sealed surface having high surface quality, which features minimum resin absorption and a density gradient with increasing density toward the surface.

The surface resin absorption and the peel resistance are determined in the context of the present invention as described in the examples.

In a further inventive embodiment of the panel, the at least one layer (S1) additionally comprises at least one fibrous material, wherein
i) the fibrous material comprises fibers in the form of one or more laminas of chopped fibers, webs, scrims, knits and/or weaves, preferably in the form of scrims or weaves, more preferably in the form of scrims or weaves having a basis weight per scrim or weave of 150 to 2500 g/m², and/or
ii) the fibrous material comprises fibers of organic, inorganic, metallic or ceramic fibers, preferably polymeric fibers, basalt fibers, glass fibers, carbon fibers or natural fibers, more preferably glass fibers or carbon fibers.

The details described above are applicable to the natural fibers and the polymeric fibers.

A layer (S1) additionally comprising at least one fibrous material is also referred to as fiber-reinforced layer, especially as fiber-reinforced resin layer if the layer (S1) comprises a resin.

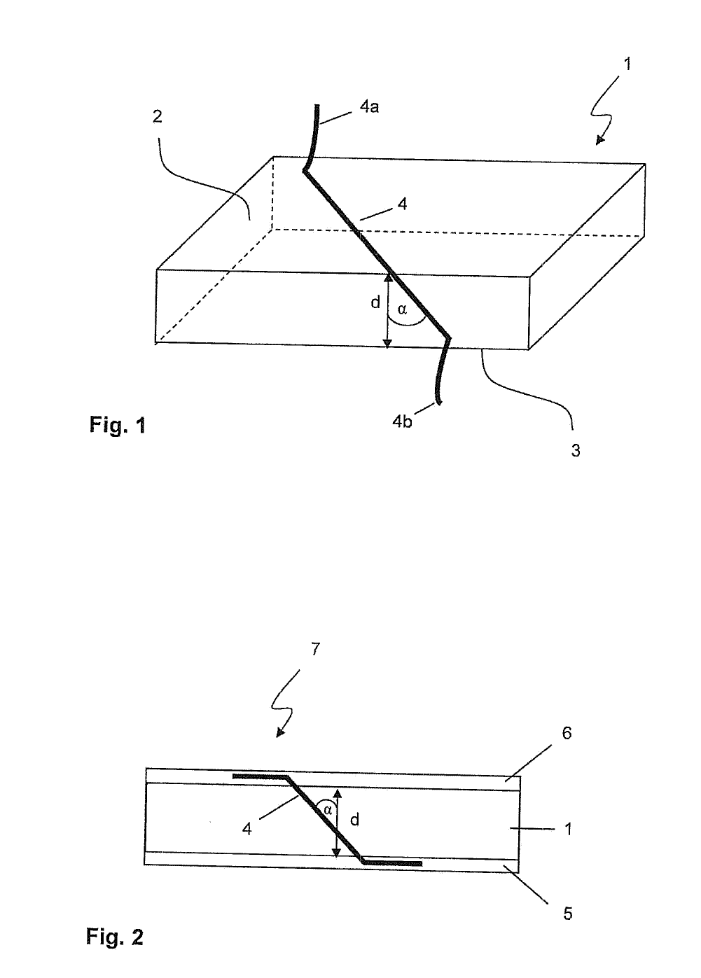

FIG. 2 shows a further preferred embodiment of the present invention. A two-dimensional side view of a panel (7) of the invention is shown, comprising a molding (1) of the invention, as detailed above, for example, within the context of the embodiment of FIG. 1. Unless stated otherwise, the reference numerals have the same meaning in the case of other abbreviations in FIGS. 1 and 2.

In the embodiment according to FIG. 2, the panel of the invention comprises two layers (S1) represented by (5) and (6). The two layers (5) and (6) are each on mutually opposite sides of the molding (1). The two layers (5) and (6) are preferably resin layers or fiber-reinforced resin layers. As further apparent from FIG. 2, the two ends of the fibers (4) are surrounded by the respective layers (5) and (6).

It is optionally possible for one or more further layers to be present between the molding (1) and the first layer (5) and/or between the molding (1) and the second layer (6). As described above for FIG. 1, FIG. 2 also shows, for the sake of simplicity, a single fiber (F) with (4). With regard to the number of fibers or fiber bundles, in practice, analogous statements apply to those detailed above for FIG. 1.

The present invention further provides a process for producing the molding of the invention, wherein at least one fiber (F) is partly introduced into the extruded foam, as a result of which the fiber (F) is present with the fiber region (FB2) within the molding and is surrounded by the extruded foam, while the fiber region (FB1) of the fiber (F) projects out of a first side of the molding and the fiber region (FB3) of the fiber (F) projects out of a second side of the molding.

The present invention further provides a process for producing the molding of the invention, wherein at least one fiber (F) is partly introduced into the extruded foam, as a result of which the fiber (F) is present with the fiber region (FB2) within the molding and is surrounded by the extruded foam, while the fiber region (FB1) of the fiber (F) projects out of a first side of the molding and the fiber region (FB3) of the fiber (F) projects out of a second side of the molding, as a result of which the fiber (F) has been introduced into the extruded foam at an angle α of 10° to 70° relative to the thickness direction (d) of the molding.

Suitable methods of introducing the fiber (F) and/or a fiber bundle are in principle all those known to those skilled in the art. Suitable processes are described, for example, in WO 2006/125561 or in WO 2011/012587.

In one embodiment of the process of the invention, the at least one fiber (F) is partially introduced into the extruded foam by sewing it in using a needle, preference being given to effecting the partial introduction by steps a) to f):
a) optionally applying at least one layer (S2) to at least one side of the extruded foam,
b) producing one hole per fiber (F) in the extruded foam and in any layer (S2), the hole extending from a first side to a second side of the extruded foam and through any layer (S2),
c) providing at least one fiber (F) on the second side of the extruded foam,
d) passing a needle from the first side of the extruded foam through the hole to the second side of the extruded foam, and passing the needle through any layer (S2),
e) securing at least one fiber (F) on the needle on the second side of the extruded foam, and
f) returning the needle along with the fiber (F) through the hole, such that the fiber (F) is present with the fiber region (FB2) within the molding and is surrounded by the extruded foam, while the fiber region (FB1) of the fiber (F) projects from a first side of the molding or from any layer (S2) and the fiber region (FB3) of the fiber (F) projects from a second side of the molding,
more preferably with simultaneous performance of steps b) and d).

The application of at least one layer (S2) in step a) can be effected, for example, as described above during and/or directly after step IV).

In a particularly preferred embodiment, steps b) and d) are performed simultaneously. In this embodiment, the hole from the first side to the second side of the extruded foam is produced by the passing of a needle from the first side of the extruded foam to the second side of the extruded foam.

In this embodiment, the introduction of the at least one fiber (F) may comprise, for example, the following steps:
a) optionally applying a layer (S2) to at least one side of the extruded foam,
b) providing at least one fiber (F) on the second side of the extruded foam,
c) producing one hole per fiber (F) in the extruded foam and in any layer (S2), the hole extending from a first side to a second side of the extruded foam and through any layer (S2), and the hole being produced by the passing of a needle through the extruded foam and through any layer (S2),
d) securing at least one fiber (F) on the needle on the second side of the extruded foam,
e) returning the needle along with the fiber (F) through the hole, such that the fiber (F) is present with the fiber region (FB2) within the molding and is surrounded by the extruded foam, while the fiber region (FB1) of the fiber (F) projects from a first side of the molding or from any layer (S2) and the fiber region (FB3) projects from a second side of the molding,
f) optionally cutting off the fiber (F) on the second side and
g) optionally cutting open the loop of the fiber (F) formed at the needle.

In a preferred embodiment, the needle used is a hook needle and at least one fiber (F) is hooked into the hook needle in step d).

In a further preferred embodiment, a plurality of fibers (F) are introduced simultaneously into the extruded foam according to the steps described above.

The present invention further provides a process for producing the panel of the invention, in which the at least one layer (S1) in the form of a reactive viscous resin is applied to a molding of the invention and cured, preferably by liquid impregnation methods, more preferably by pressure- or vacuum-assisted impregnation methods, especially preferably by vacuum infusion or pressure-assisted injection methods, most preferably by vacuum infusion. Liquid impregnation methods are known as such to those skilled in the art and are described in detail, for example, in Wiley Encyclopedia of Composites (2nd Edition, Wiley, 2012), Parnas et al. (Liquid Composite Moulding, Hanser, 2000) and Williams et al. (Composites Part A, 27, p. 517-524, 1997).

Various auxiliary materials can be used for production of the panel of the invention. Suitable auxiliary materials for production by vacuum infusion are, for example, vacuum film, preferably made from nylon, vacuum sealing tape, flow aids, preferably made from nylon, separation film, preferably made from polyolefin, tearoff fabric, preferably made from polyester, and a semipermeable film, preferably a membrane film, more preferably a PTFE membrane film, and absorption fleece, preferably made from polyester. The choice of suitable auxiliary materials is guided by the component to be manufactured, the process chosen and the materials used, specifically the resin system. In the case of use of resin systems based on epoxide and polyurethane, preference is given to using flow aids made from nylon, separation films made from polyolefin, tearoff fabric made from polyester, and a semipermeable films as PTFE membrane films, and absorption fleeces made from polyester.

These auxiliary materials can be used in various ways in the processes for producing the panel of the invention. Panels are more preferably produced from the moldings by applying fiber-reinforced outer plies by means of vacuum infusion. In a typical construction, for production of the panel of the invention, fibrous materials and optionally further layers are applied to the upper and lower sides of the moldings. Subsequently, tearoff fabric and separation films are positioned. In the infusion of the liquid resin system, it is possible to work with flow aids and/or membrane films. Particular preference is given to the following variants:
i) use of a flow aid on just one side of the construction, and/or
ii) use of a flow aid on both sides of the construction, and/or
iii) construction with a semipermeable membrane (VAP construction); the latter is preferably draped over the full area of the molding, on which flow aids, separation film and tearoff fabric are used on one or both sides, and the semipermeable membrane is sealed with respect to the mold surface by means of vacuum sealing tape, the absorption fleece is inserted on the side of the semipermeable membrane remote from the molding, as a result of which the air is evacuated upward over the full area, and/or
iv) use of a vacuum pocket made from membrane film, which is preferably positioned at the opposite gate side of the molding, by means of which the air is evacuated from the opposite side to the gate.

The construction is subsequently equipped with gates for the resin system and gates for the evacuation. Finally, a vacuum film is applied over the entire construction and sealed with sealing tape, and the entire construction is evacuated. After the infusion of the resin system, the reaction of the resin system takes place with maintenance of the vacuum.

The present invention also provides for the use of the molding of the invention or of the panel of the invention for rotor blades, in wind turbines, in the transport sector, in the construction sector, in automobile construction, in shipbuilding, in rail vehicle construction, for container construction, for sanitary installations and/or in aerospace.

The present invention is elucidated hereinafter by examples.

### EXAMPLES

### Example 1

a) Production of the Foams

For all the inventive experiments, various extruded foams (examples IF1 to IF6) are used. For comparison, polymer foams were produced by the particle foaming process (comparative examples CF7 and CF8). Table 1 gives an overview of the foams used and the characteristic properties thereof. The individual foams are produced as follows and then trimmed to 20 mm for the reinforcement:

IF1, IF2 and IF3:

The foam slabs of the invention are produced in a tandem extrusion system. 100 parts polystyrene (PS 148H, BASF) are supplied continuously to a melting extruder together with flame retardant and additives (0.2 part talc). The flame retardants and additives are in the form of masterbatches in polystyrene (PS 148H, BASF). Through an injection port incorporated in the melting extruder (ZSK 120), blowing agents (CO₂, ethanol, i-butane) are fed in continuously. The total throughput including the blowing agents is 750 kg/h. The blowing agent-containing melt is cooled down in a downstream cooling extruder (KE 400) and extruded through a slot die. The foaming melt is taken off by a heated calibrator, the surfaces of which have been coated with Teflon, via a conveyor belt at different takeoff speeds and formed to slabs. Typical slab dimensions prior to mechanical processing are about width 700 mm (y direction) and thickness 50 mm (z direction).

IF4:

Analogously to IF1, the foam slab is produced in a tandem extrusion system. The melting extruder (ZSK 120) is supplied continuously with polyphenylene ether masterbatch (PPE/PS masterbatch, Noryl C6850, Sabic) and polystyrene (PS 148H, BASF), in order to produce an overall blend consisting of 25 parts PPE and 75 parts PS. In addition, additives such as talc (0.2 part) are metered in via the intake as a PS masterbatch (PS 148H, BASF). Blowing agents (CO₂, ethanol and i-butane) are injected into the injection port under pressure. The total throughput including the blowing agents and additives is 750 kg/h. The blowing agent-containing melt is cooled down in a downstream cooling extruder (ZE 400) and extruded through a slot die. The foaming melt is taken off by a heated calibrator, the surfaces of which have been coated with Teflon, via a conveyor belt and formed to slabs. Typical slab dimensions prior to mechanical processing are about width 800 mm (y direction) and thickness 60 mm (z direction).

IF5:

Analogously to IF1, the same tandem extrusion system is used with the same throughputs. The polymer used is a blend of 50 parts styrene-maleic anhydride polymer (SMA) (Xiran SZ26080, Polyscope) and 50 parts styrene-acrylonitrile polymer (SAN) (VLL25080, BASF). In addition, nucleating agents (0.2 part talc) and stabilizers (0.2 part Tinuvin 234) are added. The blowing agents used are CO₂, acetone and i-butane.

IF6:

Polyester foams are foam-extruded through a multihole die in an extrusion system. The thermoplastic polymers (dried PET beads) are melted in the melting zone of the twin screw extruder (screw diameter=132 mm, ratio of length to diameter=24) and mixed with nucleating agent. After the melting, cyclopentane is added as blowing agent. The total throughput is about 150 kg/h. Directly after addition of the blowing agent, the homogeneous melt is cooled by means of the downstream housings and the static mixer. Before it reaches the multihole die, the melt has to pass through a melt filter. The expandable melt is foamed by means of the multihole die and the individual strands are combined to a block by means of a calibrator unit. The extruded slabs are subsequently subjected to finishing by material removal to a constant outer geometry and joined by thermal welding parallel to the extrusion direction. The mean density of the foam is 60 kg/m³.

CF7:

The foam used is a polyester-based molded foam. The expandable beads and the foam slabs are produced analogously to WO 2012/020112, example 7.

CF8:

The foam used is a polystyrene-based molded foam which is produced as a foam slab in a particle foaming machine and then sawn into slabs (raw material basis: Styropor P326, BASF).

b) Characterization of the Foams

The properties of the foams are determined as follows:
Glass transition temperature (T_{G}): Glass transition temperature is determined according to ISO 11357-2 (July 2014 version) at a heating rate of 20 K/min under a nitrogen atmosphere from the second heating run.
Anisotropy: For the determination of anisotropy, microscope images of the cells of the middle region of the foams are evaluated statistically. The largest dimension of the cells is referred to as “a direction”, and the two other, orthogonally oriented dimensions (b direction and c direction) result therefrom. Anisotropy is calculated as the quotient between the a direction and c direction.
Orientation of the a direction of the cell relative to the thickness direction (d); angle γ: The orientation of the a direction of the cell is likewise evaluated by means of microscope images. The angle formed between the a direction and the thickness direction (d) gives the orientation.
Smallest dimension of the cell (c direction): Analogously to anisotropy, the smallest dimension of the cells is determined by statistical analysis of the microscope images.
Compressive strength in z direction: Compressive strength is determined in accordance with DIN EN ISO 844 (as per German version October 2009).
Ratio of compressive strength of the foam in z direction to the compressive strength of the foam in x direction (compressive strength z/x): The ratio of compressive strength in z direction to the compressive strength in x direction is determined by the quotient of the two individual values.
closed-cell content: closed-cell content is determined according to DIN EN ISO 4590 (as per German version August 2003).
Density: The density of the pure foams is determined according to ISO 845 (October 2009 version).
Resin absorption: For resin absorption, foams are compared after material has been removed from the surface by planing. As well as the resin systems used, the foam slabs and glass rovings, the following auxiliary materials are used: nylon vacuum film, vacuum sealing tape, nylon flow aid, polyolefin separation film, polyester tearoff fabric and PTFE membrane film and polyester absorption fleece. Panels are produced from the moldings by applying fiber-reinforced outer plies by means of vacuum infusion. Two plies of Quadrax glass rovings (E glass SE1500, OCV; textile: Saertex, isotropic laminate [0°/−45°/90°45°] with 1200 g/m² in each case) each are applied to the upper and lower sides of the foams. For the determination of the resin absorption, a separation film is inserted between the foam and the glass rovings, in contrast with the standard production of the panels. In this way, the resin absorption of the pure foam is determinable. The tearoff fabric and the flow aids are mounted on either side of the glass rovings. The construction is subsequently equipped with gates for the resin system and gates for the evacuation. Finally, a vacuum film is applied over the entire construction and sealed with sealing tape, and the entire construction is evacuated. The construction is prepared with a glass surface on an electrically heatable stage.
The resin system used is an amine-curing epoxide (resin: BASF Baxxores 5400, curing agent: BASF Baxxodur 5440, mixing ratio and further processing according to data sheet). After the two components have been mixed, the resin is evacuated at down to 20 mbar for 10 minutes. At a resin temperature of 23⁺/₋2° C., infusion is effected onto the preheated construction (stage temperature: 35° C.). By means of a subsequent temperature ramp of 0.3 K/min from 35° C. to 75° C. and isothermal curing at 75° C. for 6 h, it is possible to produce panels consisting of the moldings and glass fiber-reinforced outer plies.
At the start, the foams are analyzed according to ISO 845 (October 2009 version), in order to obtain the apparent density of the foam. After the resin system has cured, the processed panels are trimmed in order to eliminate excess resin accumulations in the edge regions as a result of imperfectly fitting vacuum film. Subsequently, the outer plies are removed and the foams present are analyzed again by ISO 845. The difference in the densities gives the absolute resin absorption. Multiplication by the thickness of the foam then gives the corresponding resin absorption in kg/m².
Vacuum stability: Vacuum stability is assessed qualitatively. The foams are applied to an aluminum plate, covered with polyester fleece and, after application of a vacuum film, subjected to a reduced pressure in the range of 10-20 mbar. Changes in dimensions are observed qualitatively.
Thermoformability: Thermoformability is assessed qualitatively. For this purpose, a heated aluminum body is applied to the foam under gentle pressure and formability is assessed while simultaneously avoiding thermal degradation.

TABLE 1
Foams and essential properties

| | | Foam | | | | | | | |
|---|---|---|---|---|---|---|---|---|---|
| | | IF1 | IF2 | IF3 | IF4 | IF5 | IF6 | CF7 | CF8 |
| Production process | (—) | extrusion | extrusion | extrusion | extrusion | extrusion | extrusion | beads | beads |
| Polymer | (—) | PS | PS | PS | PPE/PS | SMA/ | polyester | polyester | PS |
| | | | | | | SAN | | | |
| Glass transition | (° C.) | n.a. | n.a. | n.a. | n.a. | n.a. | n.a. | 118 | n.a. |
| temperature | | | | | | | | | |
| Anisotropy of the | (—) | 1.3 | 1.3 | 1.4 | 1.2 | 1.1 | 1.2 | no | no |
| main cell axes | | | | | | | | | |
| γ | (°) | 0 | 90 | 0 | 0 | 0 | 0 | — | — |
| c direction | (mm) | 0.09 | 0.09 | 0.14 | 0.07 | 0.08 | 0.25 | n.a. | n.a. |
| Compressive strength in | (MPa) | 0.82 | 0.81 | 0.4 | 0.77 | 0.35 | 0.70 | 0.35 | 0.48 |
| z direction | | | | | | | | | |
| Compressive strength z/x | (—) | 3.6 | 3.4 | 1.5 | 3.9 | 4.0 | 4.1 | — | — |
| closed-cell content | (%) | >95 | >95 | >95 | >95 | >95 | >95 | n.a. | n.a. |
| Thickness (z direction) | (mm) | 20 | 20 | 20 | 20 | 20 | 20 | 20 | 20 |
| Resin absorption | (kg/m²) | 0.2 | 0.2 | 0.2 | 0.2 | 0.1 | 1.8 | 2.0 | n.a. |
| Density | (kg/m³) | 47 | 47 | 32 | 48 | 31 | 60 | 51 | 47 |
| Compressive strength to | (kPa/(kg/m³)) | 17 | 5 | 12 | 16 | 11 | 12 | 7 | 10 |
| density | | | | | | | | | |
| Vacuum stability | (—) | very good | good | good | very good | very good | very good | very good | very good |
| Thermoformability | (—) | good | good | good | good | good | very good | good | good |

The extruded foams of the invention are notable for high anisotropy, a high closed-cell content and good vacuum stability. Moreover, all extruded foams are formable by thermal processes. In addition, high compressive strengths in thickness direction can be achieved at low densities, and resin absorption, particularly in the case of IF1 to IF5, can be kept very low.

c) Production of the Moldings (Reinforcement of the Foams)

All foams are reinforced with glass fibers. The moldings are produced as follows; the properties of the moldings are shown in table 2. Depending on the experiment, hand specimens ranging up to larger samples are produced.

CM1:

The foam IF1 is reinforced with glass fibers (rovings, S2 glass, 406 tex, AGY). The glass fibers are introduced in the form of rovings at an angle α of 0°. The glass fibers have been introduced in a regular rectangular pattern with equal distances a₁=a₂ 12 mm. On both sides, about 5.5 mm of the glass fibers have additionally been left as excess at the outer ply, in order to improve the binding to the glass fiber mats that will be introduced later as outer plies. The fibers or fiber rovings are introduced in an automated manner by a combined needle/hook process. First of all, a hook needle (diameter of about 0.80 mm) is used to penetrate completely from the first side to the second side of the extruded foam. On the second side, a roving is hooked into the hook of the hook needle and then pulled from the second side by the needle back to the first side of the extruded foam. Finally, the roving is cut off on the second side and the roving loop formed is cut open at the needle. The hook needle is thus ready for the next operation.

IM2:

The foam IF1 is reinforced in analogy to CM1 with glass fibers (rovings, S2 glass, 406 tex, AGY). The glass fibers are introduced in the form of rovings at an angle α of 45° in four different spatial directions at an angle β of 90°.

CM3:

The foam IF2 is reinforced analogously to CM1; only the angle ε is different.

CM4:

The foam IF3 is reinforced analogously to CM1.

IM5:

The foam IF4 is reinforced analogously to IM2.

IM6:

The foam IF4 is reinforced analogously to IM2. Prior to the reinforcement, slotted slabs are produced by material-removing processing by means of circular saws. The slot separation in the longitudinal and transverse directions is 30 mm. The slots are introduced only on one side of the slab with a slot width of 2 mm and a slot depth of 19 mm (slab thickness of 20 mm).

IM7:

The production is analogous to IM6. In addition to the introduction of the slots, a textile backing textile (canvas fabric, 50 g/m², E glass with thermoplastic binder) is applied by thermal means on the unslotted side.

IM8:

The foam IF4 is reinforced analogously to IM5. The difference is that a different hook needle (diameter about 1.12 mm) and a thicker roving (E glass, SE1500, 900 tex, 3B) are used.

IM9:

The foam IF4 is reinforced with a barbed hook needle. For this purpose, chopped glass fibers composed of rovings (E glass) having a length of 30 mm are applied over the full area of the foam and then pressed into and through the foam by needle bonding with a needle bar having several barbed hook needles. After the needles have been withdrawn, a large portion of the fibers remains in the foam; excess fibers at the surface are removed by suction. The step is repeated for all desired directions. The proportion of fibers in the different directions is virtually identical.

IM10:

The foam IF5 is reinforced analogously to IM2.

IM11:

The foam IF6 is reinforced analogously to IM2.

CM12:

The foam CF7 is reinforced analogously to IM2.

CM13:

The foam CF8 is reinforced analogously to IM2.

d) Characterization of the Moldings
Drapability: The drapability of the moldings is determined qualitatively. For this purpose, the moldings are placed onto a curved mold having a radius of curvature of 2 m. The fitting to the curvature of the mold and the avoidance of loss of material or defects in the molding are assessed.
Sewing resistance: For the assessment of manufacturing-related advantages in reinforcement by rovings, comparative penetration tests are conducted. The needle is mechanically secured to a dynamic testing machine. Subsequently, the needle is used to penetrate the foam at 5 different points and the force-distance profile is recorded. The sinusoidal half-wave has an amplitude of 25 mm, and so the needle penetrates 25 mm into the foam. On needle impact, the needle has a velocity of 2 m/s. According to the sample thickness, the sample is penetrated. The sample surface forms the zero point of the measurement. The force is measured by a piezoelectric force transducer. The values reported are mean values from the measurements and reflect the force at penetration depth 10 mm in newtons (N).

TABLE 2
Moldings and essential properties

| | | Molding | | | | | | | | | | | | |
|---|---|---|---|---|---|---|---|---|---|---|---|---|---|---|
| | (—) | CM1 | IM2 | CM3 | CM4 | IM5 | IM6 | IM7 | IM8 | IM9 | IM10 | IM11 | CM12 | CM13 |
| Foam | (—) | IF1 | IF1 | IF2 | IF3 | IF4 | IF4 | IF4 | IF4 | IF4 | IF5 | IF6 | CF7 | CF8 |
| Fiber | (—) | hook | hook | hook | hook | hook | hook | hook | hook | barbed | hook | hook | hook | hook |
| introduction | | needle | needle | needle | needle | needle | needle | needle | needle | hook | needle | needle | needle | needle |
| method | | | | | | | | | | | | | | |
| Fiber material | (—) | S glass | S glass | S glass | S glass | S glass | S glass | S glass | E glass | E glass | S glass | S glass | S glass | S glass |
| Fiber thickness | (tex) | 406 | 406 | 406 | 406 | 406 | 406 | 406 | 900 | 900 | 406 | 406 | 406 | 406 |
| α | (°) | 0 | 45 | 0 | 0 | 45 | 45 | 45 | 45 | 45 | 45 | 45 | 45 | 45 |
| β | (°) | — | 90 | — | — | 90 | 90 | 90 | 90 | 90 | 90 | 90 | 90 | 90 |
| ε | (°) | 0 | 45 | 90 | 0 | 45 | 45 | 45 | 45 | 45 | 45 | 45 | — | — |
| Number | (—) | 1 | 4 | 1 | 1 | 4 | 4 | 4 | 4 | 4 | 4 | 4 | 4 | 4 |
| of fiber | | | | | | | | | | | | | | |
| orientations | | | | | | | | | | | | | | |
| Fiber | (mm × | 12 × 12 | 12 × 12 | 12 × 12 | 12 × 12 | 12 × 12 | 12 × 12 | 12 × 12 | 12 × 12 | 20 × 20 | 12 × 12 | 12 × 12 | 12 × 12 | 12 × 12 |
| separations | mm) | | | | | | | | | | | | | |
| (a₁ × a₂) | | | | | | | | | | | | | | |
| Fiber region | (%) | 63 | 71 | 63 | 63 | 71 | 71 | 71 | 71 | 51-56 | 71 | 71 | 71 | 71 |
| (FB2)/overall | | | | | | | | | | | | | | |
| fiber (F) | | | | | | | | | | | | | | |
| Number | (1/m²) | 6944 | 27778 | 6944 | 6944 | 27778 | 27778 | 27778 | 27778 | 10000 | 27778 | 27778 | 27778 | 27778 |
| of fibers | | | | | | | | | | | | | | |
| Sewing | (N) | 7.4 | 7.9 | 9.1 | 6.1 | — | — | — | | — | — | — | — | — |
| resistance | | | | | | | | | | | | | | |
| Introduction | (—) | no | no | no | no | no | yes | yes | no | no | no | no | no | no |
| of slots | | | | | | | | | | | | | | |
| Application of | (—) | no | no | no | no | no | no | yes | no | no | no | no | no | no |
| further layers | | | | | | | | | | | | | | |
| (S2) | | | | | | | | | | | | | | |
| Drapability | (—) | no | no | no | no | no | good | very | no | no | no | no | no | no |
| | | | | | | | | good | | | | | | |

The extruded foams of the invention can be processed in a simple and reproducible manner by means of fibers to give moldings of the invention. It is advantageous to introduce fibers at angles ε of less than 60° to the largest dimension (a direction) of the cells, since it is thus possible to reduce the penetration resistance in the reinforcement process (see rise in angle and in sewing resistance from CM1 to CM3). In addition, it is possible to further reduce penetration resistance by means of extruded foams of reduced density (CM4). Drapability of the moldings can be achieved by means of slots, which are advantageously introduced prior to the introduction of the fibers into the moldings (IM6 versus IM5). A further improvement can be achieved by means of a textile carrier on the reverse side, which stops the cut foam elements from breaking free and improves the overall integrity (IM7). Finally, it is possible to utilize different fiber types (IM8), introduction processes (IM9) and extruded foams (IM10, IM11).

e) Production of the Panels

The moldings are subsequently used to produce panels by application of fiber-reinforced outer plies by means of vacuum infusion (VI), as described above in section a) (determination of resin absorption). Rather than the foam, however, the molding is used; by contrast with the determination of resin absorption, in addition, no separation film is introduced between the moldings and the glass rovings.

f) Characterization of the Panels
Shear stiffness and stability: Shear properties are determined according to DIN 53294 at 23° C. and 50% relative humidity (February 1982 version).
Peel resistance: The peel resistance of the panels is determined with single cantilever beam (SCB) samples. The molding height of the samples is 20 mm; the outer layers each consist of quasi-isotropic glass fiber-reinforced epoxy resin layers of thickness about 2 mm. The samples are tested in a Zwick Z050 tensile tester at a speed of 5 mm/min, with application of the load to each specimen and removal thereof in a repeated manner (3 to 4 times). The growth in cracking or the increase is assessed visually in each load cycle (Δa). The force-distance plot is used to ascertain the crack growth energy (ΔU). This is used to ascertain the tear strength or peeling resistance as

$${G}_{IC} = \frac{Δ U}{B Δ a}$$

with B as sample width.
Crease resistance: Resistance to creasing of the outer plies (microwrinkling) is calculated on the basis of the measured base properties of the material. Blister resistance to creasing of the outer plies can be determined as

$${σ}_{c} = 0.85 \cdot \sqrt[3]{{E}_{C 3} \cdot {E}_{f} \cdot {G}_{C}}$$

with E_{C3}: core stiffness in thickness direction, E_{f}: stiffness of the outer layer, G_{C}: shear stiffness of the core material

TABLE 3
Panels of the invention and essential properties

| | | Panel | | | | | | | | | | | | |
|---|---|---|---|---|---|---|---|---|---|---|---|---|---|---|
| | (—) | CP1 | IP2 | CP3 | CP4 | IP5 | IP6 | IP7 | IP8 | IP9 | IP10 | IP11 | CP12 | CP13 |
| Molding | (—) | CM1 | IM2 | CM3 | CM4 | IM5 | IM6 | IM7 | IM8 | IM9 | IM10 | IM11 | CM12 | CM13 |
| Layer | (—) | VI | VI | VI | VI | VI | VI | VI | VI | VI | VI | VI | VI | VI |
| application | | | | | | | | | | | | | | |
| Layer | (—) | epoxy/ | epoxy/ | epoxy/ | epoxy/ | epoxy/ | epoxy/ | epoxy/ | epoxy/ | epoxy/ | epoxy/ | epoxy/ | epoxy/ | epoxy/ |
| construction | | E glass | E glass | E glass | E glass | E glass | E glass | E glass | E glass | E glass | E glass | E glass | E glass | E glass |
| | | fibers | fibers | fibers | fibers | fibers | fibers | fibers | fibers | fibers | fibers | fibers | fibers | fibers |
| Shear stiffness | (MPa) | 14* | — | — | — | 147 | — | — | 201 | 115 | 114 | — | 105* | 101* |
| Shear | (MPa) | — | — | — | — | 2.1 | — | — | — | — | — | — | — | — |
| resistance | | | | | | | | | | | | | | |
| Peel resistance | (kJ/m²) | — | — | — | — | 3.5 | — | — | — | — | — | — | — | — |
| Crease | (MPa) | 230 | 230 | 178 | 195 | 233 | 233 | 233 | 233 | 82 | 152 | 238 | 108 | 164 |
| resistance* | | | | | | | | | | | | | | |

*calculated values

All panels of the invention are notable for high crease resistance coupled with low density (IP2 and IP5 to IP11), specifically in the case of orientation of the main cell axes parallel to the slab orthogonal (IP2 versus CP3). It is thus possible to avoid potential failure in use. It is additionally found to be particularly advantageous to use foams that are produced by extrusion through a slot die (IP2 and IP5 to IP10). Peel resistance and shear stiffness/resistance are high in the case of low densities. By contrast, the crease resistance of the comparative foams is low, or the densities required to achieve higher characteristics are high.

### Example 2 (Design of a Panel for Illustration of the Preferred Fiber Angles, Theoretical Determination)

The mechanical properties of a molding comprising the extruded foam IF4 were determined theoretically. The fibers (F) used were glass fibers (rovings, E-Glass, 900 tex, 3B). The angle α at which the fibers (F) were assumed to have been introduced was in the range from 0° to 80°. At angles α>0°, the fibers (F) were assumed to be in four different spatial directions at an angle β (0°, 90°, 180°, 270°) to one another. Regular rectangular patterns with equal distances a=16 mm and, at an angle α of 0°, 625 glass fiber elements/m² were assumed.

The shear moduli were calculated for different angles α. For this purpose, a strut and tie model with flexible struts was used for connection of the upper and lower outer layers. The outer layers were assumed to be infinitely stiff. The extruded foam had a thickness of 25 mm, a shear stiffness G=14 MPa, and a compression stiffness E=MPa. The resin absorption at the surface of the foam was assumed to be 0.2 kg/m².

The fiber bundles consist of E glass fibers. As a result of the manufacturing process, the reinforcing elements had a thickness of 2×900 tex (=1800 tex); the fiber volume content was assumed to be 40% by volume and the diameter to be 1.5 mm. This gives rise to the figures reported in table 4 for shear moduli, densities of the molding in the processed panel and specific shear moduli as a function of the angle α.

TABLE 4

| | | | Density of the | Specific shear |
|---|---|---|---|---|
| | Angle α | Shear modulus | molding | moduli |
| Example | (°) | (MPa) | (kg/m³) | (MPa/(kg/m³) |
| CM14 | 0 | 15 | 129 | 0.12 |
| IM15 | 10 | 27 | 129 | 0.21 |
| IM16 | 20 | 60 | 132 | 0.45 |
| IM17 | 30 | 104 | 137 | 0.76 |
| IM18 | 40 | 145 | 145 | 1.00 |
| IM19 | 45 | 160 | 151 | 1.06 |
| IM20 | 50 | 169 | 159 | 1.06 |
| IM21 | 60 | 168 | 183 | 0.92 |
| IM22 | 70 | 138 | 234 | 0.59 |
| CM23 | 80 | 83 | 388 | 0.21 |

It is clearly apparent that shear stiffness increases rapidly with rising fiber angle before dropping again over and above about 60°.

For the use of the panels, flexural stiffness or blister resistance is generally very important. The blister stiffness of a panel with parallel symmetric outer layers can be determined as follows with standard force introduced at the end:

$$P \geq \frac{{π}^{2} D}{( {l}^{2} + \frac{{π}^{2} Dt}{{Gd}^{2}} )} b$$

where F is the force before occurrence of global blistering (=blister resistance), D is the flexural stiffness of the panel, G is the shear modulus of the molding (=core material), t is the thickness of the molding of the panel, b is the width of the panel and d is the thickness of the molding (=core material) plus one outer layer thickness.

The flexural stiffness of the panel is calculated from:

$$D = \frac{{E}_{D} {t}_{D}^{3}}{6} + \frac{{E}_{D} {t}_{D} {d}^{2}}{2} + \frac{{E}_{K} {t}_{K}^{3}}{12}$$

E_{D} is the modulus of elasticity of the outer layer, E_{K} is the modulus of elasticity of the molding (=core material), t_{D} is the thickness of the outer layer per side, tₖ is the thickness of the molding (=core material), d is the thickness of the core material plus the thickness of one outer layer.

The width of the panel was assumed to be 0.1 m; the length was 0.4 m. The thickness of the molding was 25 mm, the thickness of the outer layer 2 mm, and the modulus of elasticity of the outer layer 39 GPa.

The moldings used were the moldings according to examples CM14 to CM23.

Table 5 states the results.

TABLE 5

| | | Density of the | Blister | |
|---|---|---|---|---|
| | Angle α | molding | stability | Specific blister stability |
| Example | (°) | (kg/m³) | (kN) | (kN/(kg/m³) |
| CP14 | 0 | 129 | 35 | 0.28 |
| IP15 | 10 | 129 | 55 | 0.43 |
| IP16 | 20 | 132 | 89 | 0.67 |
| IP17 | 30 | 137 | 113 | 0.82 |
| IP18 | 40 | 145 | 126 | 0.87 |
| IP19 | 45 | 151 | 129 | 0.85 |
| IP20 | 50 | 159 | 131 | 0.82 |
| IP21 | 60 | 183 | 130 | 0.71 |
| IP22 | 70 | 234 | 123 | 0.52 |
| CP23 | 80 | 388 | 102 | 0.26 |

It is clearly apparent that blister stability increases rapidly with rising angle α before dropping again over and above about 60°.

1.-16. (canceled)

17. A molding made of extruded foam, wherein at least one fiber (F) is present with a fiber region (FB2) within the molding and is surrounded by the extruded foam, while a fiber region (FB1) of the fiber (F) projects from a first side of the molding and a fiber region (FB3) of the fiber (F) projects from a second side of the molding, and the extruded foam is produced by an extrusion process comprising the following steps:
I) providing a polymer melt in an extruder,
II) introducing at least one blowing agent into the polymer melt provided in step I) to obtain a foamable polymer melt,
III) extruding the foamable polymer melt obtained in step II) from the extruder through at least one die aperture into an area at lower pressure, with expansion of the foamable polymer melt to obtain an expanded foam, and
IV) calibrating the expanded foam from step III) by conducting the expanded foam through a shaping tool to obtain the extruded foam,
wherein the fiber (F) has been introduced into the extruded foam at an angle α of 10° to 70° relative to the thickness direction (d) of the molding and wherein two or more fibers (F) are at an angle β to one another in the molding, where the angle β is in the range of β=360°/n where n is an integer.

18. The molding according to claim 17, wherein
i) the polymer melt provided in step I) comprises at least one additive, or
at least one additive is added during step II) to the polymer melt or between step II) and step III) to the foamable polymer melt, or
iii) at least one additive is applied during step III) to the expanded foam or during step IV) to the expanded foam, or
iv) at least one layer (S2) is applied to the extruded foam during or directly after step IV), or
v) the following process step is conducted after step IV):
V) material-removing processing of the extruded foam obtained in step IV).

19. The molding according to claim 17, wherein the extruded foam is based on at least one polymer selected from polystyrene, polyester, polyphenylene oxide, a copolymer prepared from phenylene oxide, a copolymer prepared from styrene, polyaryl ether sulfone, polyphenylene sulfide, polyaryl ether ketone, polypropylene, polyethylene, polyamide, polyamide imide, polyether imide, polycarbonate, polyacrylate, polylactic acid, polyvinyl chloride, or a mixture thereof.

20. The molding according to claim 19, wherein the polymer being styrene, a mixture of polystyrene and poly(2,6-dimethylphenylene oxide), a mixture of a styrene-maleic anhydride polymer and a styrene-acrylonitrile polymer (SMA/SAN), or a styrene-maleic anhydride polymer (SMA).

21. The molding according to claim 20, wherein a copolymer prepared from styrene having, as comonomer for styrene, a monomer selected from α-methylstyrene, ring-halogenated styrenes, ring-alkylated styrenes, acrylonitrile, acrylic esters, methacrylic esters, N-vinyl compounds, maleic anhydride, butadiene, divinylbenzene and butanediol diacrylate.

22. The molding according to claim 17, wherein the extruded foam comprises cells, where
i) at least 50% of the cells are anisotropic, or
the ratio of the largest dimension (a direction) to the smallest dimension (c direction) of at least 50% of the cells is ≧1.05, or
iii) the mean size of the smallest dimension (c direction) of at least 50% of the cells is in the range from 0.01 to 1 mm, or
iv) at least 50% of the cells are orthotropic or transversely isotropic, or
at least 50% of the cells, based on their largest dimension (a direction), are aligned at an angle γ of ≦45° relative to the thickness direction (d) of the molding, or
vi) the extruded foam has a closed cell content of at least 80%, or
vii) the fibers (F) are at an angle ε of ≦60° relative to the largest dimension (a direction) of at least 50% of the cells of the extruded foam.

23. The molding according to claim 17, wherein
i) at least one of the mechanical properties of the extruded foam is/are anisotropic, or
ii) at least one of the elastic moduli of the extruded foam behave(s) in the manner of an anisotropic material, or
iii) the ratio of the compressive strength of the extruded foam in thickness (z direction) to the compressive strength of the extruded foam in length (x direction) or the ratio of the compressive strength of the extruded foam in thickness (z direction) to the compressive strength of the extruded foam in width (y direction) is ≧1.1.

24. The molding according to claim 15, wherein
i) the extruded foam has a thickness (z direction) in the range from 4 to 200 mm, a length (x direction) of at least 200 mm and a width (y direction) of at least 200 mm, or
ii) the surface of at least one side of the molding has at least one recess and at least one recess being produced on the surface of at least one side of the molding after the performance of step IV), or
iii) the surface of at least one side of the molding has at least one recess and at least one recess being produced on the surface of at least one side of the molding after the performance of step V).

25. The molding according to claim 17, wherein
i) the fiber (F) is a single fiber or a fiber bundle, or
ii) the fiber (F) is an organic, inorganic, metallic or ceramic fiber or a combination thereof, or
iii) the fiber (F) is used in the form of a fiber bundle having a number of single fibers per bundle of 300 to 10 000 in the case of glass fibers and 1000 to 50 000 in the case of carbon fibers, or
iv) the fiber region (FB1) and the fiber region (FB3) each independently account for 1% to 45% and the fiber region (FB2) for 10% to 98% of the total length of a fiber (F), or
v) the fiber (F) has been introduced into the extruded foam at an angle α of 30° to 60° relative to the thickness direction (d) of the molding, or
vi) in the molding, the first side of the molding from which the fiber region (FB1) of the fiber (F) projects is opposite the second side of the molding from which the fiber region (FB3) of the fiber (F) projects, or
vii) the molding comprises a multitude of fibers (F), or comprises more than 10 fibers (F) or fiber bundles per m².

26. A panel comprising at least one molding according to claim 17 and at least one layer (S1).

27. The panel according to claim 26, wherein the layer (S1) comprises at least one resin.

28. The panel according to claim 27, wherein the resin being based on epoxides, acrylates, polyurethanes, polyamides, polyesters, unsaturated polyesters, vinyl esters or mixtures thereof.

29. The panel according to claim 26, wherein the layer (S1) additionally comprises at least one fibrous material, where
i) the fibrous material comprises fibers in the form of one or more laminas of chopped fibers, webs, scrims, knits or weaves, or
ii) the fibrous material comprises organic, inorganic, metallic or ceramic fibers.

30. The panel according to claim 26, wherein the panel has two layers (S1) and the two layers (S1) are each mounted on a side of the molding opposite the respective other side in the molding.

31. The panel according to claim 26, wherein
i) the fiber region (FB1) of the fiber (F) is in partial or complete contact with the first layer (S1), or
ii) the fiber region (FB3) of the fiber (F) is in partial or complete contact with the second layer (S1), or
iii) the panel has at least one layer (S2) between at least one side of the molding and at least one layer (S1), or
iv) the at least one layer (S1) comprises a resin and the extruded foam of the molding of the panel has a surface resin absorption of ≦2000 g/m², or
v) the at least one layer (S1) comprises a resin and the panel has a peel resistance of ≧200 J/m².

32. A process for producing a molding according to claim 17, which comprises partly introducing at least one fiber (F) into the extruded foam, as a result of which the fiber (F) is present with the fiber region (FB2) within the molding and is surrounded by the extruded foam, while the fiber region (FB1) of the fiber (F) projects out of a first side of the molding and the fiber region (FB3) of the fiber (F) projects out of a second side of the molding, as a result of which the fiber (F) has been introduced into the extruded foam at an angle α of 10° to 70° relative to the thickness direction (d) of the molding.

33. The process according to claim 32, wherein at least one fiber (F) is partially introduced into the extruded foam by sewing it in using a needle.

34. The process according to claim 33, wherein the partial introduction being effected by means of steps a) to f):
a) optionally applying at least one layer (S2) to at least one side of the extruded foam,
b) producing one hole per fiber (F) in the extruded foam and in any layer (S2), the hole extending from a first side to a second side of the extruded foam and through any layer (S2),
c) providing at least one fiber (F) on the second side of the extruded foam,
d) passing a needle from the first side of the extruded foam through the hole to the second side of the extruded foam, and passing the needle through any layer (S2),
e) securing at least one fiber (F) on the needle on the second side of the extruded foam, and
f) returning the needle along with the fiber (F) through the hole, such that the fiber (F) is present with the fiber region (FB2) within the molding and is surrounded by the extruded foam, while the fiber region (FB1) of the fiber (F) projects from a first side of the molding or from any layer (S2) and the fiber region (FB3) of the fiber (F) projects from a second side of the molding.

35. The process according to claim 34, wherein the process is carried out with simultaneous performance of steps b) and d).

36. A process of producing a panel according to claim 26, which comprises producing, applying and curing the at least one layer (S1) in the form of a reactive viscous resin on a molding according to claim 17.

37. The process according to claim 36, which is carried out by liquid impregnation methods.

38. The use of a molding according to claim 17 or of a panel according to claim 34 for rotor blades in wind turbines, in the transport sector, in the construction sector, in automobile construction, in shipbuilding, in rail vehicle construction, for container construction, for sanitary installations or in aerospace.
